(19) United States
(12) Patent Application Publication
(10) Pub. No.: US 2011/0208602 A1
(43) Pub. Date: Aug. 25, 2011

(54) SALE DATA PROCESSING TERMINAL AND CONTROL METHOD THEREOF

(75) Inventor: Motohiro Katsumata, Shizuoka (JP)

(73) Assignee: TOSHIBA TEC KABUSHIKI KAISHA, Tokyo (JP)

(21) Appl. No.: 13/032,696

(22) Filed: Feb. 23, 2011

(30) Foreign Application Priority Data
Feb. 24, 2010 (JP) 2010-039138

(51) Int. Cl. G06Q 40/00

(52) U.S. Cl. 705/16

(57) ABSTRACT

A sale data processing terminal includes: a receiver unit that receives an operation input by a user's operation; a registering unit that registers transaction details of a transaction received by the receiver unit in sale data; an account adjusting unit that performs an account adjusting process of summing up the transactions registered in the sale data, when a predetermined adjusting time at which the account adjusting process of summing up sales is performed arrives and the transaction details are not being received; and a non-adjustment alarming unit that gives an alarm indicating a non-adjusted state where the account adjusting process is not performed, when the predetermined adjusting time arrives but the transaction details are being received.

### CROSS-REFERENCE TO RELATED APPLICATION

This application is based upon and claims the benefit of priority from the Japanese Patent Application No. 2010-39138, filed on Feb. 24, 2010, the entire contents of which are incorporated herein by reference.

### FIELD

The present invention relates to a sale data processing terminal and a control method thereof.

### BACKGROUND

Conventionally, POS (Point Of Sale) terminals for goods sale registering and accounting processes are disposed in a store. In the store, since sale data from the POS terminals is collected and daily sale is determined, it is necessary to perform an account adjusting process of summing up the daily sale using the POS terminals.

A clerk may not exist in each POS terminal. Accordingly, in order to prevent the account adjusting process from not being performed and the daily sale from not being determined for the reason of forgetting the start operation of the account adjusting process, a POS terminal automatically performing the account adjusting process at a predetermined time is known. JP-2713810-B discloses a POS terminal that performs an account adjusting process when a predetermined start time of the account adjusting process is equal to the counted current time.

However, in the POS terminal disclosed in JP-2713810-B, the account adjusting process is not performed when an operator performs the goods sale registering and accounting processes at the predetermined start time of the account adjusting process. Accordingly, it is necessary to perform the account adjusting process by means of a clerk's operation. Therefore, a check operation of causing a clerk to check that the POS terminals perform the account adjusting process is necessary. However, the operation of individually checking by what POS terminal the account adjusting process is not performed is troublesome.

### BRIEF DESCRIPTION OF THE DRAWINGS

FIG. 1 is a block diagram illustrating the functional configuration of a POS terminal according to an embodiment.

FIG. 2 is a flow diagram illustrating exemplary operations of the POS terminal according to the embodiment.

FIG. 3 is a diagram illustrating the operations by cases.

### DETAILED DESCRIPTION

According to one embodiment, there is provided a sale data processing terminal including: a receiver unit that receives an operation input by a user's operation; a registering unit that registers transaction details of a transaction received by the receiver unit in sale data; an account adjusting unit that performs an account adjusting process of summing up the transactions registered in the sale data, when a predetermined adjusting time at which the account adjusting process of summing up sales is performed arrives and the transaction details are not being received; and a non-adjustment alarming unit that gives an alarm indicating a non-adjusted state where the account adjusting process is not performed, when the predetermined adjusting time arrives but the transaction details are being received.

According to another embodiment, there is provided a control method of a sale data processing terminal including a receiver unit that receives an operation input by a user's operation and a registering unit that registers transaction details of a transaction received by the receiver unit in sale data, the method including: performing an account adjusting process of summing up the transactions registered in the sale data, when a predetermined adjusting time at which the account adjusting process of summing up sales is performed arrives and the transaction details are not being received; and giving an alarm indicating a non-adjusted state where the account adjusting process is not performed, when the predetermined adjusting time arrives but the transaction details are being received.

Hereinafter, a sale data processing terminal and a control method thereof according to an embodiment will be described in detail with reference to the accompanying drawings. The sale data processing terminal and the control method thereof according to this embodiment are used in a POS terminal installed in a store such as a supermarket.

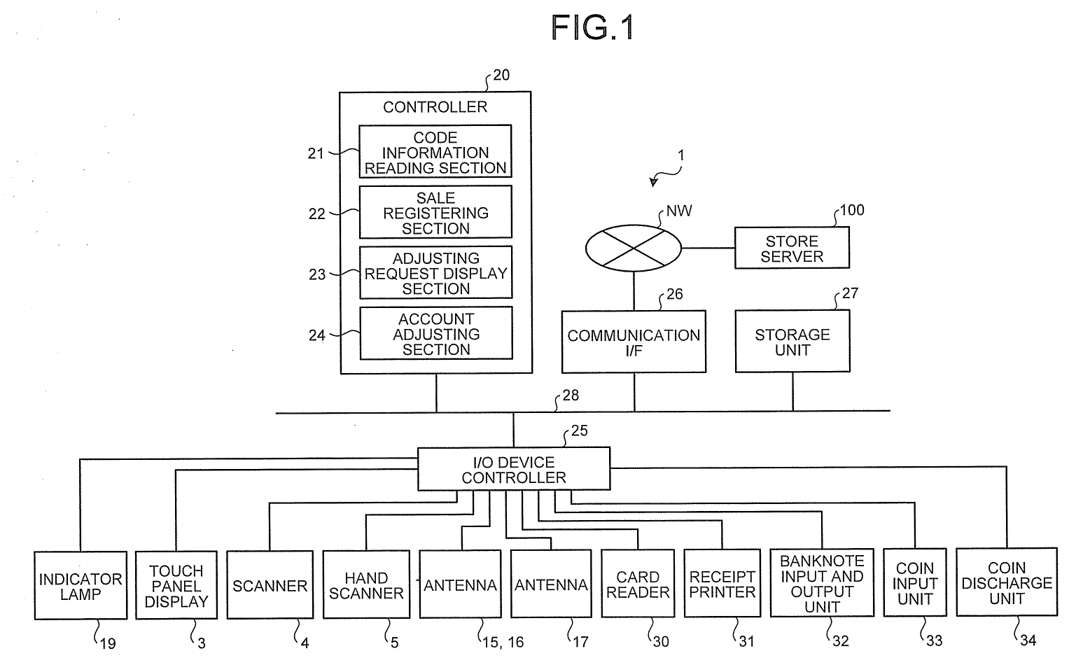

First, the functional configuration of a POS terminal 1 will be described. FIG. 1 is a block diagram illustrating the functional configuration of the POS terminal 1 according to this embodiment. The POS terminal 1 performs a goods sale registering process or a payment accounting process. The POS terminal 1 sums up the sales from data registered in transactions by an accounting process and outputs a summing result to a higher-ranked device such as a store server. In the following description, a process flow of transacted goods sale registration in a transaction or payment therefor is referred to as “accounting” and a process flow of summing up sales of a store from sale data registered in transactions is referred to as “account adjustment”.

As shown in FIG. 1, the POS terminal 1 includes a controller 20, an I/O device controller 25, a communication I/F 26, and a storage unit 27 and the units are electrically connected to each other via a bus 28.

The controller 20 includes a CPU (Central Processing Unit), a ROM (Read Only Memory) , a RAM (Random Access Memory), and an RTC (Real Time Clock). The controller 20 comprehensively controls the operation of the POS terminal 1 by allowing the CPU to execute various programs. The ROM stores various programs performed by the CPU and various data. The RAM provides a work area for temporarily storing data or programs when the CPU executes various programs. Specifically, the RAM stores sale data including sale records of goods or various picture display data to be displayed on a touch panel display 3. The RTC counts the current time.

The controller 20 controls I/O devices such as an indicator lamp 19, the touch panel display 3, a scanner 4, a hand scanner 5, antennas 15, 16, and 17, a card reader 30, a receipt printer 31, a banknote input and output unit 32, a coin input unit 33, and a coin discharge unit 34 via the I/O device controller 25 and the bus 28. The controller 20 controls the overall system of the POS terminal 1 by controlling the communication I/F 26 and the storage unit 27 via the bus 28.

The indicator lamp 19 notifies a device state to a clerk depending on the light types such as lighting, extinction, and flickering. The touch panel display 3 is a liquid crystal display of a touch panel type. The touch panel display 3 displays a guidance picture for informing an operator (a clerk or a customer in case of a self-checkout POS terminal) of an operating method of the POS terminal 1, an input picture for inputting goods information of goods to which a code symbol is not attached, a goods registering picture for showing goods information read by the scanner 4 or the hand scanner 5, or an accounting picture for displaying a total amount of money of goods, a received amount of money, and an amount of change and selecting a payment method. The scanner 4 optically reads a code symbol by causing an operator to bring the code symbol such as a barcode or a two-dimensional code attached to goods at a close position of a reading window of the scanner 4. The hand scanner 5 is used to read a code symbol attached to goods which is difficult to bring at a close position of the reading window of the scanner 4. For example, since a code symbol attached to a large-sized product such as a cardboard or a long product is difficult to bring at the close position of the reading window of the scanner 4, the code symbol can be read using the hand scanner 5.

The antennas 15 and 16 are disposed in the vicinity of the reading window of the scanner 4, wirelessly communicate with an RFID (Radio Frequency Identification) tag, and transmit data for deactivating the RFID tag to the RFID tag attached to the goods. For example, by deactivating the RFID tag at the time of accounting, a theft-preventing alarm using the RFID tag is made not to sound for the carrying of an authentic product purchased. The antenna 17 is disposed at an end of the hand scanner 5 or the like and transmits data for deactivating the RFID tag to the RFID tag attached to the goods. Accordingly, the POS terminal 1 can deactivate the RFID tag for large-sized products.

The communication I/F 26 is an interface for transmitting and receiving data to and from an information device such as a store server 100 via a communication network NW such as a LAN (Local Area Network). Through the communication I/F 26, the controller 20 outputs an account adjustment result (sale data indicating the details of transactions or a summing-up result of the sales) to the store server 100. The controller outputs the account adjustment result (the sale data indicating the details of transactions or the summing-up result of the sales) to the store server 100 connected to the communication I/F 26 via the communication network NW. The store server 100 manages transaction data accounted by one or plural POS terminals 1 installed in the store. Specifically, the store server 100 may be a personal computer and performs a store closing process of receiving the account adjustment result of the POS terminal 1 installed in the store and summing up the daily sales of the store.

The storage unit 27 is a memory device such as an HDD (Hard Disk Drive) and stores goods master data on the goods treated in the stored or sale data registered in the POS terminal 1 by the accounting, in addition to various programs or data. The goods master data stores goods information such as a unit price and a goods type for each goods code uniquely allocated to the goods. By referring to the goods master data on the basis of the goods code read from the code symbol at the time of accounting, it is possible to specify a purchased product or to input the unit price thereof. The sale data stores sale information such as a goods code, the number of goods, the amount of money, and a transaction time of the goods purchased in the corresponding transaction for each transaction number uniquely allocated to each transaction. By referring to the transaction time of the sale data and the like at the time of adjusting an account, it is possible to sum up the sales for a predetermined time (for example, one day).

The card reader 30 reads information of a customer's point card or credit card. The receipt printer 31 prints a receipt after the accounting process. The receipt printer 31 may print a journal after the account adjusting process. The banknote input and output unit 32 processes banknotes to be input or output. The coin input unit 33 processes coins to be input and the coin discharge unit 34 processes coins to be discharged.

The controller 20 includes a code information reading section 21, a sale registering section 22, an adjusting request display section 23, and an account adjusting section 24 which are functional configurations embodied by executing the above-mentioned various programs.

The code information reading section 21 reads goods information such as a goods code stored in the code symbol from the goods as a signal obtained by reading the code symbol such as a barcode or a two-dimensional code attached to the goods by the use of the scanner 4 or the hand scanner 5.

The sale registering section 22 registers the transaction details of a transaction, which are received by causing the code information reading section 21 to read the goods information, in the sale data. The sale registering section 22 registers the sales of the goods on the basis of the read goods information when the code information reading section 21 reads the goods information. When an “accounting” key is selected on the touch panel display 3, the sale registering section 22 calculates and displays the total amount of money for the purchased goods on the touch panel display 3, receives an operator's operation on whether to select cash payment or card payment from the touch panel, and performs the accounting process based on the selected payment. The reception of the transaction details of a transaction may include the selection of payment to the end of the accounting process.

The adjusting request display section 23 displays an adjusting request for prompting the operator to start an account adjusting process on the touch panel display 3 with the arrival of the start time of the adjusting request for requesting the operator to start the account adjusting process. Specifically, a pop-up such as “please adjust an account” is displayed on the touch panel display 3. This pop-up is displayed as a very front window on the screen so as to attract attention. The pop-up may be deleted by means of a predetermined operation such as a subsequent operation (for example, a key input at the time of accounting or the reading of the goods information) or a selecting operation of “do not adjust an account”. Since the pop-up is deleted in this way, the pop-up does not continuously interfere with the operator's operation of sale registering in accounting. When the operator does not adjust an account and does not perform any operation, the pop-up is continuously displayed and thus a clerk having seen the pop-up can start the account adjusting process.

When a forcible adjusting time at which the account adjusting process is forcible started arrives and the operator performs the sale registering operation in accounting, the adjusting request display section 23 performs an indicator display for informing a non-adjusted state where the account adjusting process is not performed after the forcible adjusting time by the use of at least one of the touch panel display 3 and the indicator lamp 19. As a specific example of the indicator display, an icon image indicating the non-adjusted state is displayed in a predetermined area of the touch panel display 3 or the lighting type of the indicator lamp 19 is set to a lighting state indicating the non-adjusted state. In this way, the indicator display is not noticeable when the operator performs the sale registering operation in accounting, unlike the pop-up displayed as the very front window on the screen, thereby not interfering with the operator's accounting operation.

When the account is not adjusted after the adjusting request start time, the POS terminal 1 performs the account adjusting process with the arrival of the forcible adjusting time for forcibly starting the account adjusting process. When the forcible adjusting time arrives and the operator performs the sale registering operation in accounting, the operator makes more of the accounting operation and thus does not perform the account adjusting process. Therefore, by the above-mentioned indicator display is performed by the adjusting request display section 23, the clerk can see that the POS terminal 1 does not perform the account adjusting process at once. In this way, when finding the POS terminal 1 not performing the account adjusting process by the indicator display, the clerk causes the POS terminal 1 to perform the account adjusting process by operating the touch panel display 3 or the like, and then causes the store server 100 to perform the store closing process again, that is, performs a restoration operation for determining the accurate sale of the store.

The adjusting request start time and the fordible adjusting time are preset depending on the running of the store. For example, the adjusting request start time is earlier than the forcible adjusting time and is set to the store closing time or 1 hour before the store server 100 performs the store closing process. The forcible adjusting time is set to 30 minutes after the store closing time or 30 minutes before the store server 100 performs the store closing process. The setting of the adjusting request start time and the forcible adjusting time is performed in the ROM of the store server 100 or the controller 20. The adjusting request display section 23 detects the arrival of the adjusting request start time and the forcible adjusting time set in the ROM by the use of the RTC. The store server 100 in which the adjusting request start time and the forcible adjusting time are set may notify the arrival to the POS terminal 1 and the adjusting request display section 23 may detect the notification.

The account adjusting section 24 performs the account adjusting process of summing up the sales for a predetermined time (for example, one day) on the basis of the sale data stored in the storage unit 27 and outputting the summing-up result and the sale data indicating the details of the transactions for the predetermined time to the store server 100. The account adjusting process in the account adjusting section 24 is performed when the transaction details are not being received at the time of the arrival of the forcible adjusting time or when the accounting adjusting instruction is received by means of the operation on the touch panel display 3 (details of which will be described later)

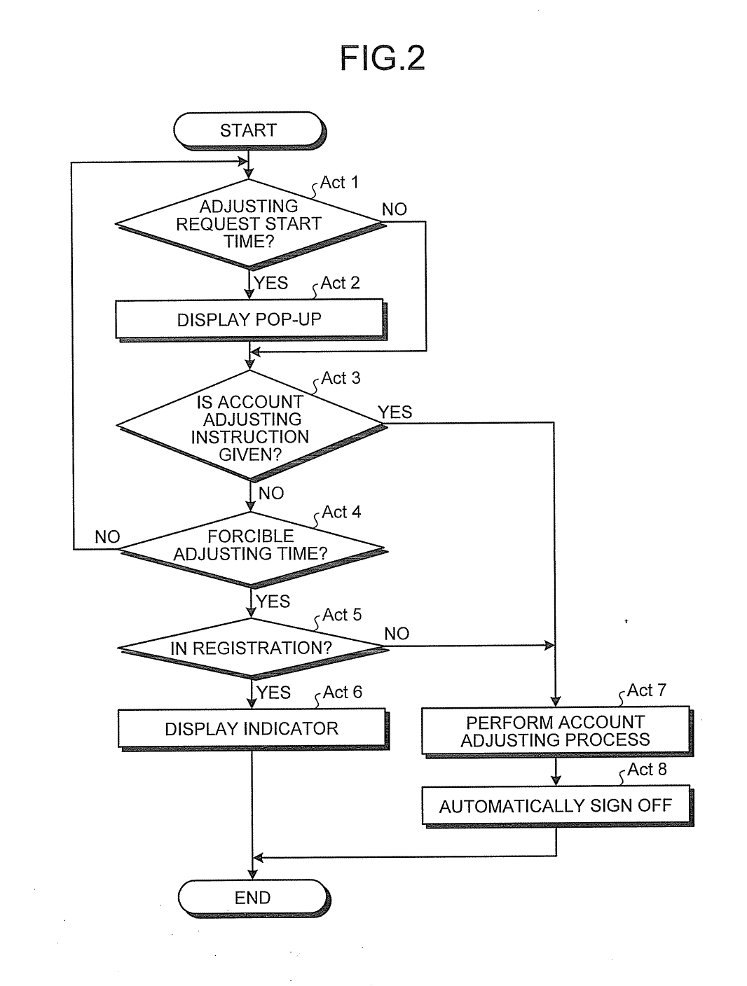

The process flow of the POS terminal 1 embodied by the programs stored in the ROM or the like under the control of the controller 20 will be described with reference to FIG. 2. More specifically, a series of processes involved in the pop-up display with the arrival of the adjusting request start time or the indicator display with the arrival of the forcible adjusting time will be described. FIG. 2 is a flow diagram illustrating the process flow in the POS terminal 1 according to this embodiment.

As shown in FIG. 2, when the process flow is started, the controller 20 determines whether the adjusting request start time arrives on the basis of the notification from the RTC or the store server 100 (Act 1). When it is determined that the adjusting request start time does not arrive (NO in Act 1), the controller 20 performs the process of Act 3. When it is determined that adjusting request start time arrives (YES in Act 1), the adjusting request display section 23 of the controller 20 displays the above-mentioned pop-up on the touch panel display 3 (Act 2) and then performs the process of Act 3.

In Act 3, the controller 20 determines whether an account adjusting instruction is given by the operation of the touch panel display 3. When it is determined that the account adjusting instruction is given (YES in Act 3), the controller 20 performs the process of Act 7. When it is determined that the account adjusting instruction is not given (NO in Act 3), the controller 20 determines whether the forcible adjusting time arrives on the basis of the notification from the RTC or the store server 100 (Act 4).

When it is determined that the forcible adjusting time does not arrive (NO in Act 4), the controller 20 performs the process of Act 1 again. Accordingly, the POS terminal 1 repeatedly performs the processes of Acts 1 to 4 until the forcible adjusting time arrives (YES in Act 4) or the account adjusting instruction is given (YES in Act 3).

When the forcible adjusting time arrives (YES in Act 4), the controller 20 determines whether the terminal is in an in-registration state in which the goods registering picture is displayed on the touch panel display 3 and the operator is performing the sale registering operation (Act 5). When the terminal is in the in-registration state (YES in Act 5), the adjusting request display section 23 of the controller 20 performs the indicator display using the touch panel display 3 or the indicator lamp 19 (Act 6). Accordingly, when the forcible adjusting time arrives but it is in the in-registration state, the indicator display is performed using the touch panel display 3 or the indicator lamp 19, whereby the non-adjusted state where the account adjusting process is not performed is indicated.

When it is not in the in-registration state (NO in Act 5) or the account adjusting instruction is given (YES in Act 3), the controller 20 performs the account adjusting process using the account adjusting section 24 (Act 7), determines the daily sale, and performs an automatic sign-off, for example, automatically turns off a power source (Act 8).

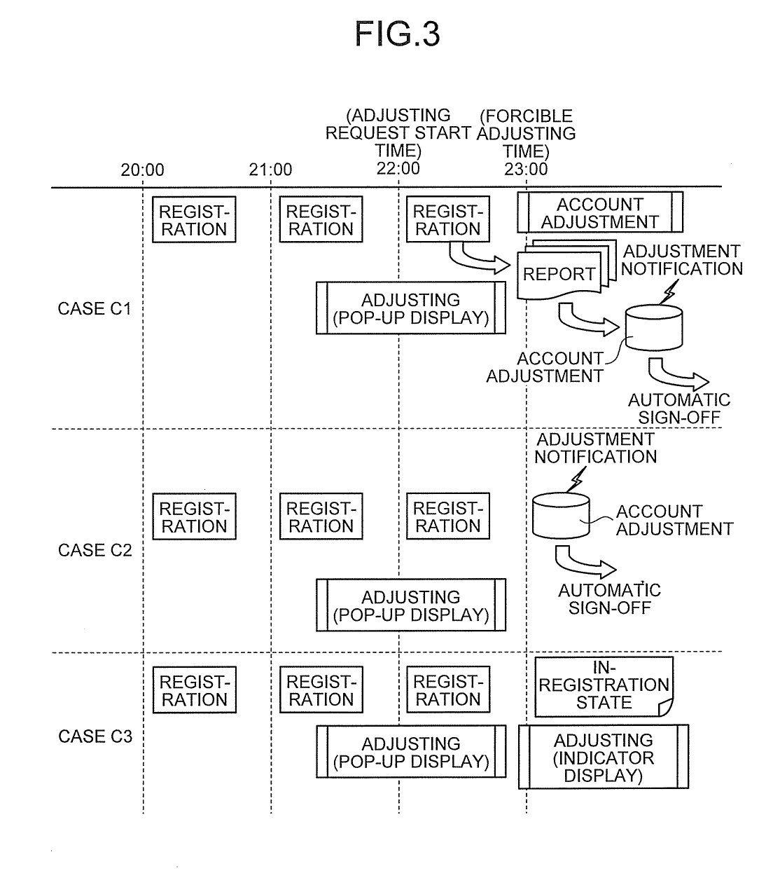

FIG. 3 is a diagram illustrating operations by cases. Specifically, operations of cases C1, C2, and C3 are shown in FIG. 3. Case C1 is a case where a clerk or the like performs an operation of starting the account adjusting process and the account adjusting process is performed, with the pop-up display due to the arrival of the adjusting request start time (22:00 in this case). Case C2 is a case where the account adjusting process is forcibly performed with the arrival of the forcible adjusting time (23:00 in this case) after the pop-up display is performed with the arrival of the adjusting request start time. Case C3 is a case where the sale registering process is being performed in accounting when the forcible adjusting time arrives after the pop-up display is performed with the arrival of the adjusting request start time.

As shown in FIG. 3, when the adjusting request start time arrives (corresponding to YES in Act 1 of FIG. 2), the adjusting request for prompting the operator to perform the operation of starting the account adjusting process is displayed as a pop-up on the touch panel display 3. Accordingly, as in the case C1, the clerk watching the pop-up can start the account adjusting process.

As in the case C2, when the forcible adjusting time arrives (corresponding to YES in Act 4 of FIG. 2) and the operator is not performing the sale registering operation (corresponding to NO in Act 5 of FIG. 2), the account adjusting process is forcibly performed. Accordingly, even when the clerk and the like do not perform the operation of starting the account adjusting process after the display of the pop-up, it is possible to forcibly perform the account adjusting process. As in the case C3, when the forcible adjusting time arrives (corresponding to YES in Act 4 of FIG. 2) and the operator is performing the sale registering operation (corresponding to YES in Act 5 of FIG. 2), the indicator display gives an alarm indicating the non-adjusted state where the account adjusting process is not performed. Accordingly, the clerk can see the POS terminal 1 in the non-adjusted state and can determine the accurate sale of the store by performing the above-mentioned restoration work. The non-adjusted state where the account adjusting process is not performed may be informed by a voice from a speaker, in addition to the indicator display.

The programs executed by the controller 20 according to this embodiment are stored in advance in the storage unit 27 or the ROM and are provided. The programs executed by the controller 20 according to this embodiment may be stored as files of an installable format or executable format in a computer-readable recording medium such as a CD-ROM, a flexible disk (FD), a CD-R, and a DVD (Digital Versatile Disk) and may then be provided.

The programs executed by the controller 20 according to this embodiment may be provided by storing the programs in a computer connected to a network such as the Internet and downloading the programs via the network. The programs executed by the controller 20 according to this embodiment may be provided or distributed via the network such as the Internet.

The programs executed by the controller 20 according to this embodiment may be constructed as modules including the above-mentioned sections (the code information reading section 21, the sale registering section 22, the adjusting request display section 23, and the account adjusting section 24) and the sections may be loaded into a main memory device and may be generated in the main memory device by causing the CPU (processor) as the actual hardware to read and execute the programs from the ROM.

What is claimed is:

1. A sale data processing terminal comprising:
a receiver unit that receives an operation input by a user's operation;
a registering unit that registers transaction details of a transaction received by the receiver unit in sale data;
an account adjusting unit that performs an account adjusting process of summing up the transactions registered in the sale data, when a predetermined adjusting time at which the account adjusting process of summing up sales is performed arrives and the transaction details are not being received; and
a non-adjustment alarming unit that gives an alarm indicating a non-adjusted state where the account adjusting process is not performed, when the predetermined adjusting time arrives but the transaction details are being received.

2. The terminal according to claim 1, wherein the alarm indicating the non-adjusted state is a lighting indication of an indicator lamp.

3. The terminal according to claim 1, wherein the alarm indicating the non-adjusted state is a display of an icon image in a predetermined area on a display picture of a display unit.

4. The terminal according to claim 1, wherein an adjusting request time which is earlier than the adjusting time and at which a user is requested for an account adjusting operation for starting the account adjusting process is preset, and
wherein the terminal further comprises an adjusting request alarming unit that gives the user an adjusting request alarm indicating the request for the account adjusting operation with the arrival of the adjusting request time.

5. The terminal according to claim 4, wherein the adjusting request alarm is a pop-up display on the display picture.

6. The terminal according to claim 5, wherein the display picture is a picture for displaying the transaction details, and
wherein the pop-up display displayed on the display picture displaying the transaction details is removed by an operation received by the receiver unit.

7. The terminal according to claim 1, further comprising:
a storage unit that stores the adjusting time; and
a counter unit that counts up time and detects the arrival of the stored adjusting time.

8. The terminal according to claim 1, further comprising a communication unit that communicates with a higher-ranked device in which the adjusting time is set,
wherein the arrival of the adjusting time is detected by a notification from the higher-ranked device.

9. A control method of a sale data processing terminal including a receiver unit that receives an operation input by a user's operation and a registering unit that registers transaction details of a transaction received by the receiver unit in sale data, the method comprising:
performing an account adjusting process of summing up the transactions registered in the sale data, when a predetermined adjusting time at which the account adjusting process of summing up sales is performed arrives and the transaction details are not being received; and
giving an alarm indicating a non-adjusted state where the account adjusting process is not performed, when the predetermined adjusting time arrives but the transaction details are being received.

10. The method according to claim 9, wherein an adjusting request time which is earlier than the adjusting time and at which a user is requested for an account adjusting operation for starting the account adjusting process is preset, and
wherein the method further comprises giving the user an adjusting request alarm indicating the request for the account adjusting operation with the arrival of the adjusting request time.
